(19) United States
(12) Patent Application Publication
(10) Pub. No.: US 2012/0174573 A1
(43) Pub. Date: Jul. 12, 2012

(54) MULTI-SEGMENTED ACTIVE MATERIAL ACTUATOR

(75) Inventors: Richard J. Skurkis, Lake Orion, MI (US); Alan L. Browne, Grosse Pointe, MI (US); Nancy L. Johnson, Northville, MI (US); Nilesh D. Mankame, Ann Arbor, MI (US); Xiujie Gao, Troy, MI (US); Peter Maxwell Sarosi, Ferndale, MI (US)

(73) Assignee: GM GLOBAL TECHNOLOGY OPERATIONS LLC, DETROIT, MI (US)

(21) Appl. No.: 13/421,784

(22) Filed: Mar. 15, 2012

Related U.S. Application Data
(63) Continuation-in-part of application No. 12/397,482, filed on Mar. 4, 2009.

(51) Int. Cl. F03G 7/06

(52) U.S. Cl. 60/527

(57) ABSTRACT

A multi-segmented active material actuator producing a variable, tailored, or staged/staggered stroke in response to an activation signal, including a plurality of segments joined in series, having differing constituencies and geometric configurations, and presenting differing activation thresholds, activation periods/rates, and/or strokes as a result.

### RELATED APPLICATIONS

This patent application continues-in-part from U.S. Non-provisional patent application Ser. No. 12/397,482, entitled “SHAPE MEMORY ALLOY CABLES,” filed on Mar. 4, 2009, the disclosure of which being incorporated by reference herein.

### BACKGROUND OF THE INVENTION

1. Field of the Invention

The present disclosure generally relates to shape memory alloy actuators, and more particularly, to a multi-segmented active material actuator capable of providing staged, tailored, or variable stroke output.

2. Discussion of Prior Art

In the various mechanical arts conventional actuators (e.g., motors, solenoids, etc.) have long been used to translate a maximum anticipated load over a definite stroke for a given input signal. Active material actuators, such as shape memory alloy wire, offer various advantageous over their electro-mechanical counterparts, but are also for the most part limited to a singular stroke depending upon operative characteristics, such as length, diameter, and constituency. Where differing strokes, staging, and/or timing is desired, additional actuators are often employed and selectively engaged through a transmission, toggle, or switch. Where active materials are employed a plurality of parallel actuators are typically drivenly connected to the load and individually activated. Concernedly, it is widely appreciated that the inclusion of additional actuators adds to the complexity, weight, and cost of a system. For example, it is appreciated that control logic is often necessary to effect the proper sequence of activation/energizing where staged or variable actuation is conventionally orchestrated.

### BRIEF SUMMARY OF THE INVENTION

Responsive to the afore-mentioned concerns, the present invention provides a serially connected multi-segmented active material actuator operable to produce a variable, tailored, or staged stroke in response to an activation signal. That is to say, by use of the present invention, a driven load can be displaced varying distances, and/or incrementally over time to produce staged or staggered motion sequences of varying rates, staged or staggered motion sequences of varying stroking force level, and/or time staggered/sequenced displacement steps. Moreover, where passively activated, the invention is useful for providing environmental temperature staggered/sequenced displacement steps. Through the expanded use of active material actuation, it is appreciated that the invention reduces weight, complexity, packaging requirements, and noise (both acoustically and with respect to EMF) in comparison to conventional electro-mechanical and electro-hydraulic equivalents.

In general, the actuator includes a plurality of segments, each formed in part by an active material operable to undergo a reversible change in fundamental property when exposed to or occluded from the signal, presenting a constituency, and geometric configuration, and defining an activation threshold, activation range/period, and segment stroke based on the constituency, and configuration. The segments are fixedly interconnected, joined in series, and define differing thresholds, ranges, and/or segment strokes, due to having differing constituencies, and/or configurations.

This disclosure, including exemplary embodiments particularly employing shape memory alloy, and various methods of interconnection may be understood more readily by reference to the following detailed description of the various features of the disclosure and drawing figures associated therewith.

### BRIEF DESCRIPTION OF THE SEVERAL VIEWS OF THE DRAWING

A preferred embodiment(s) of the invention is described in detail below with reference to the attached drawing figures of exemplary scale, wherein:

FIG. 1 is an elevation of a multi-segmented active material actuator comprising a plurality of n segments having differing constituencies and interconnected by weld beads, wherein the segments are simultaneously exposed to a passive signal, in accordance with a preferred embodiment of the invention;

FIG. 2 is an elevation of a multi-segmented active material actuator comprising first and second segments having differing diameters and interconnected by a tensile link, a driven load, and a return mechanism drivenly coupled to the load antagonistic to the actuator, in accordance with a preferred embodiment of the invention;

FIG. 3 is an elevation of a multi-segmented active material actuator comprising first and second segments having differing diameters and interconnected by a crimp, in accordance with a preferred embodiment of the invention;

FIG. 4 is a partial elevation of a multi-segmented active material actuator, particularly illustrating an epoxy/adhesive/cement interconnecting element, in accordance with a preferred embodiment of the invention;

FIG. 5 is an elevation of a multi-segmented active material actuator comprising spring segments having differing constituencies and interconnected by a mechanical plug, wherein a first segment has been activated and caused to contract, in accordance with a preferred embodiment of the invention; and

FIG. 6 is an elevation of a multi-segmented active material actuator comprising segments having differing diameters, and interconnected by a gear transmission, in accordance with a preferred embodiment of the invention.

### DETAILED DESCRIPTION OF THE INVENTION

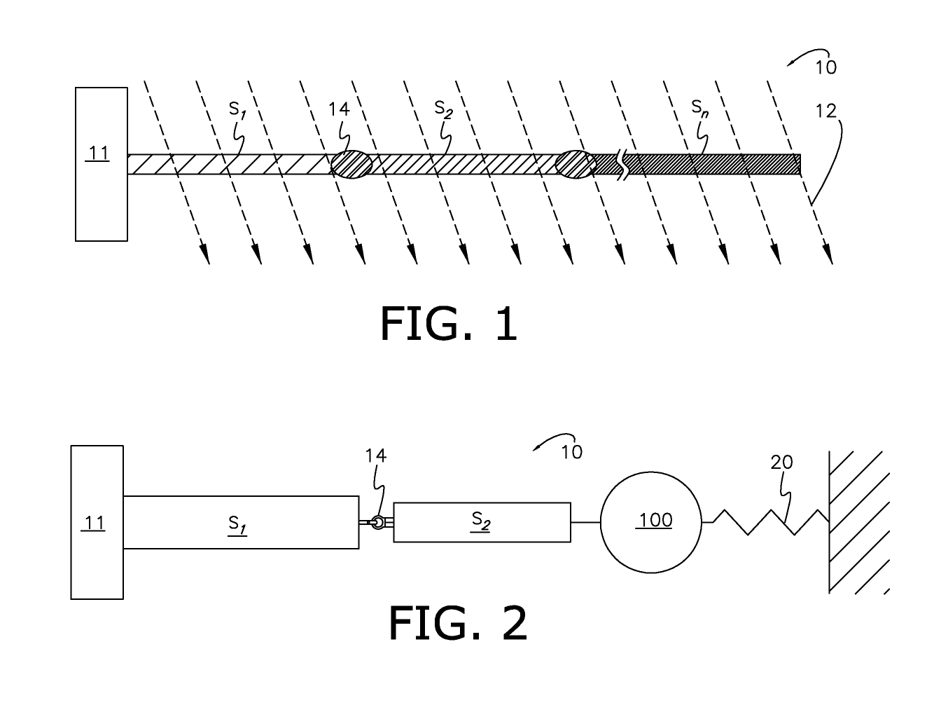

With reference to FIGS. 1-6, the present invention concerns a multi-segmented active material actuator 10 adapted to produce a variable, tailored, or staged stroke. That is to say, when the actuator 10 is exposed to a sufficient activation signal 12, it produces an overall stroke in incremental stages corresponding to the timing of activation and individual segment strokes of the multiple segments S_{1 . . . n}, or in the alternative, may effect a variable stroke dependent upon the timing and stroke of a responsive portion of the segments S_{1 . . . n}. Thus, it is within the ambit of the invention to activate the actuator 10, in a preferred embodiment, using one of a variety of activation signals. It is appreciated that the actuator 10 may be employed wherever a variable, sequential, or a staged incremental stroke is desired. The detailed description of the preferred embodiments is merely exemplary in nature and is in no way intended to limit the invention, its application, or uses.

In general, the actuator 10 is of the type fixedly attached to an anchor 11, and comprises a plurality of segments S_{1 . . . n} formed at least in part by an active material. The segments S_{1 . . . n} present differing constituencies, and/or geometric configurations, so as to define differing activation thresholds, activation ranges/periods, driving forces, and/or segment strokes (FIG. 1). The segments S_{1 . . . n} are fixedly joined in series, and drivenly configured to act as one unit. That is to say, the segments S_{1 . . . n} are configured such that a driving force produced by one segment acts upon each of the other segments intermediate the activated segment and a load 100, and then eventually to the load 100 drivenly engaged by the actuator 10. The load 100 may be distally coupled to the actuator 10 or intermediately driven, such as, for example, where the actuator 10 forms a bow-string configuration.

I. Active Material Description and Functionality

As used herein the term “active material” shall be afforded its ordinary meaning as understood by those of ordinary skill in the art, and includes any material or composite that exhibits a reversible change in a fundamental (e.g., chemical or intrinsic physical) property, when exposed to an external signal source. Thus, active materials shall include those compositions that can exhibit a change in stiffness properties, shape and/or dimensions in response to an activation signal.

Active materials suitable for use herein are those that define a workable stroke when activated, and without limitation, include shape memory alloys (SMA), ferromagnetic shape memory alloys, electroactive polymers (EAP), magnetorheological elastomers, electrorheological elastomers, magnetostrictives, electrostrictives, carbon nanofibers, high-output-paraffin (HOP) wax actuators, and the like. Depending on the particular active material, the activation signal can take the form of, without limitation, heat energy, an electric current, an electric field (voltage), a temperature change, a magnetic field, and the like. For example, a magnetic field may be applied for changing the property of the active material fabricated from magnetostrictive materials. A heat signal may be applied for changing the property of thermally activated active materials such as SMA. An electrical signal may be applied for changing the property of the active material fabricated from electroactive polymer. Of particular application, however, are shape memory alloy wires.

More particularly, shape memory alloys (SMA's) generally refer to a group of metallic materials that demonstrate the ability to return to some previously defined shape or size when subjected to an appropriate thermal stimulus. Shape memory alloys are capable of undergoing phase transitions in which their yield strength, stiffness, dimension and/or shape are altered as a function of temperature. The term “yield strength” refers to the stress at which a material exhibits a specified deviation from proportionality of stress and strain. Generally, in the low temperature, or martensite phase, shape memory alloys can be pseudo-plastically deformed and upon exposure to some higher temperature will transform to an austenite phase, or parent phase, returning to their shape prior to the deformation.

Thus, shape memory alloys exist in several different temperature-dependent phases. The most commonly utilized of these phases are the so-called martensite and austenite phases discussed above. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is called the austenite finish temperature (A_{f}).

When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). Generally, the shape memory alloys are softer and more easily deformable in their martensitic phase and are harder, stiffer, and/or more rigid in the austenitic phase. In view of the foregoing, a suitable activation signal for use with shape memory alloys is a thermal activation signal having a magnitude to cause transformations between the martensite and austenite phases.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating. Active materials comprising shape memory alloy compositions that exhibit one-way memory effects do not automatically reform, and will likely require an external mechanical force to reform the shape that was previously presented.

Intrinsic and extrinsic two-way shape memory materials are characterized by a shape transition both upon heating from the martensite phase to the austenite phase, as well as an additional shape transition upon cooling from the austenite phase back to the martensite phase. Active materials that exhibit an intrinsic shape memory effect are fabricated from a shape memory alloy composition that will cause the active materials to automatically reform themselves as a result of the above noted phase transformations. Intrinsic two-way shape memory behavior must be induced in the shape memory material through processing. Such procedures include extreme deformation of the material while in the martensite phase, heating-cooling under constraint or load, or surface modification, such as laser annealing, polishing, or shot-peening. Once the material has been trained to exhibit the two-way shape memory effect, the shape change between the low and high temperature states is generally reversible and persists through a high number of thermal cycles. In contrast, active materials that exhibit the extrinsic two-way shape memory effects are composite or multi-component materials that combine a shape memory alloy composition that exhibits a one-way effect with another element that provides a restoring force to reform the original shape.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the system with shape memory effects, super-elastic effects, and high damping capacity.

Suitable shape memory alloy materials include, without limitation, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

It is appreciated that SMA's exhibit a modulus increase of 2.5 times and a dimensional change of up to 8% (depending on the amount of pre-strain) when heated above their Martensite to Austenite phase transition temperature. It is appreciated that thermally induced SMA phase changes are typically one-way so that a biasing force return mechanism (such as a spring) would be required to return the SMA to its starting configuration once the applied field is removed. Joule heating can be used to make the entire system electronically controllable.

Ferromagnetic Shape Memory Alloys (FSMA) are a sub-class of SMA. FSMA can behave like conventional SMA materials that have a stress or thermally induced phase transformation between martensite and austenite. Additionally FSMA are ferromagnetic and have strong magneto-crystalline anisotropy, which permit an external magnetic field to influence the orientation/fraction of field aligned martensitic variants. When the magnetic field is removed, the material exhibits partial two-way or one-way shape memory. For partial or one-way shape memory, an external stimulus, temperature, magnetic field or stress may permit the material to return to its starting state. Perfect two-way shape memory may be used for proportional control with continuous power supplied. One-way shape memory is most useful for latching-type applications where a delayed return stimulus permits a latching function. External magnetic fields are generally produced via soft-magnetic core electromagnets in automotive applications. Electric current running through the coil induces a magnetic field through the FSMA material, causing a change in shape. Alternatively, a pair of Helmholtz coils may also be used for fast response.

Exemplary ferromagnetic shape memory alloys are nickel-manganese-gallium based alloys, iron-platinum based alloys, iron-palladium based alloys, cobalt-nickel-aluminum based alloys, cobalt-nickel-gallium based alloys. Like SMA these alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends, in part, on the temperature range and the type of response in the intended application.

Electroactive polymers include those polymeric materials that exhibit piezoelectric, pyroelectric, or electrostrictive properties in response to electrical or mechanical fields. An example is an electrostrictive-grafted elastomer with a piezoelectric poly(vinylidene fluoride-trifluoro-ethylene) copolymer. This combination has the ability to produce a varied amount of ferroelectric-electrostrictive molecular composite systems. These may be operated as a piezoelectric sensor or even an electrostrictive actuator.

Materials suitable for use as an electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity—(for large or small deformations), a high dielectric constant, and the like. In one embodiment, the polymer is selected such that it has a maximum elastic modulus of about 100 MPa. In another embodiment, the polymer is selected such that it has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thickness suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present disclosure may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

II. Exemplary Configurations, Applications, and Use

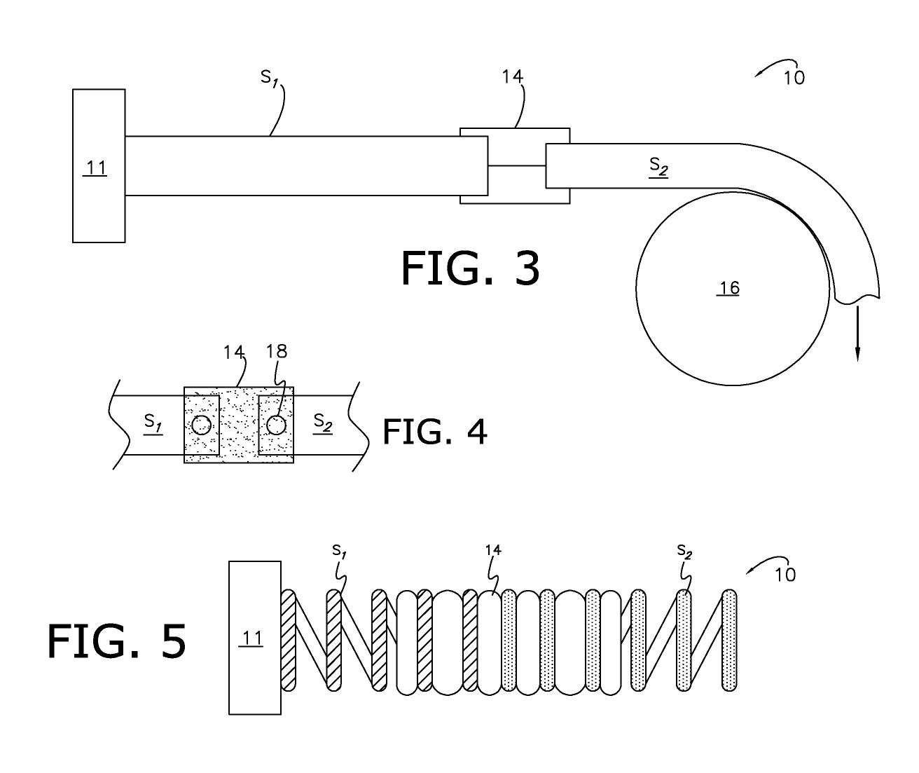

Returning to the structural configuration of the invention, the actuator 10 includes a plurality of segments S_{1 . . . n} differing in constituency, and/or geometric configuration, and physically joined by at least one interconnecting element 14. In FIG. 1, for example, a plurality of n segments S_{1 . . . n} is shown as having different constituencies, and in a linearly or coaxially joined formation. It is certainly within the ambit of the invention, however, for the actuator 10 to present a non-linear configuration, whereas, for example, a portion of the segments S_{1 . . . n} and/or elements 14 are bent about at least one pulley or other structure 16 (FIG. 3); though it is appreciated that unwanted friction and bending stress would be experienced at the bent segment(s) or element(s). To address the latter, an interconnecting element 14 comprising a pre-fabricated bend may be employed.

In the illustrated embodiments, the segments S_{1 . . . n} are shown as having wire configurations, wherein the term “wire” is non-limiting, and shall include other similar geometric configurations presenting tensile load strength/strain capabilities, such as cables, bundles, braids, ropes, strips, chains, and other elements to the extent compatible with the structural limitations of the present invention, but are not limited thereto.

The segments S_{1 . . . n} may comprise different active materials categorically, or present different variations or species of the same active material. For example, segments S_{1,2} of equivalent stroke may comprise SMA and an electrostrictive element respectively, so that where both compose a circuit (not shown), the electrostrictive is selectively caused to activate instantaneously, while the SMA element is activated after a heating period dependent upon ambient (e.g., ambient temperature, humidity, fluid flow, etc.), circuit (e.g., current amperage, etc.) and inherent (e.g., segment cross-sectional area, emissivity, etc.) conditions. As previously stated, plural types of active material segments may be used, so that actuator 10 is responsive to a greater number of signal types. A magnetostrictive segment, for example, may be added, so that the actuator 10 is responsive to a magnetic field in addition to an electric potential across the electrostrictive segment and a passive thermal signal engaging the SMA segment. Thus, the actuator 10 may be activated in various manners to effect a single stroke, or by a combination of signals to produce a maximum stroke.

In a preferred embodiment, segments of SMA wire may present differing constituencies that vary an aspect of activation. Whereas it is appreciated that transformation start temperatures are fundamentally a material property, the segments S_{1 . . . n} may have different activation temperatures and/or differing delta Ts (i.e., change in temperature) between the Martensitic finish (M_{f}) and Austenitic finish (A_{f}) temperatures depending upon their constituency and whether the temperature is increasing or decreasing. More particularly, it is appreciated that segments varying in terms of any of the four characterizing temperatures M_{f}, the Martensitic start (Mₛ), Austenitic start (Aₛ), and A_{f} will produce responses that differ. For example, the first segment S₁ may present a richer nickel concentration in comparison to the second segment S₂, so as to present a lower transformation start temperature and/or shorter transformation temperature range or actuation cycle delta-T's. It is appreciated by those of ordinary skill in the art that raising the Nickel content in SMA by just 1% above a 50% atomic weight constituency lowers the transformation start temperature more than 100° C.

Similarly, and as shown in FIGS. 2 and 3, first and second segments S_{1,2} of identical constituency may present differing geometric configurations, so as to present differing activation thresholds, or periods/ranges. For example, the segments S_{1,2} may present SMA wires having differing diameters, wherein it is appreciated that the diametrically larger segment will present a greater heating period due to greater surface area exposure, greater mass, and an inverse relationship to electrical resistivity (where Joule heated). Where the temperature is passively cycled (i.e., increased in environment), it is appreciated that segments S_{1 . . . n} with different diameters but common materials will start to actuate simultaneously though higher stress levels in the smaller diameter segments will delay their activation through stress induced shift in actuation temperatures.

In applications in which the temperature is increased through Joule heating, phase transition will occur first in segments of smaller diameter and/or lower activation temperature. Given that electrical resistance is an inverse function of wire segment diameter and a function of segment temperature, complex motion sequences (functions of both displacement and time) may be produced through current control, and suitable algorithms. Moreover, it is appreciated that suitable controls are required to prevent overheating of smaller segments, wherein the actuator 10 is actively activated. Thus, the segments S_{1,2}, in this configuration, produce a staged overall stroke corresponding to the timing of activation and individual stroke of each segment.

Additionally, the term “differing geometries” includes differing shapes of equal diameter, wherein the segments S_{1 . . . n} present different cross-sectional geometries, such as circles, polygons, stars, etc. More particularly, it is appreciated that differing shaped segments if subjected to the same load will have different stress levels; and that the different stress levels may be used to further produce differing values of at least one of the four critical temperatures M_{f}, Mₛ, Aₛ, and A_{f}. Differing geometries may be further presented by a plurality of parallel wires, for example, in bundle configuration versus a solid wire of equivalent diameter (e.g., three or four 0.15 cm dia. wires versus one 0.30 cm dia) and identical constituency. In this configuration, it is appreciated that the increased surface area of exposure of the bundle results in a slower rate of heat loss, and therefore, a shorter actuation period over gradual loading for the larger single wire.

As previously mentioned the segments are physically joined by at least one interconnecting element 14. The element 14 presents suitable means for transferring the driving force between adjacent segments, including but not limited to a weld bead (FIG. 1) where utilizing metallic (e.g., SMA, FSMA, etc.) materials, a crimp connector (FIG. 3), epoxy/adhesive/cement (FIG. 4), an interlocking formation (not shown) defined by adjacent segments, and combinations thereof. Where joined by epoxy/adhesive/cement, the preferred segments define through-holes 18 operable to receive the fluid material prior to curing (FIG. 4). Where the actuator 10 is limited to constriction, the element 14 may consist of a purely tensile element (FIG. 2), such as a tie, chain link, etc., so as to provide a flexible joint. In this configuration, however, a return mechanism 20, such as an extension spring (FIG. 2) drivenly coupled to the load 100 opposite the actuator 10 is preferably provided to reset the actuator 10 after use. Alternatively, in a stand-alone configuration, each joint may further consist of a compression spring (not shown) coaxially aligned with each tensile element 14.

In another embodiment, the segments S_{1 . . . n} may present springs comprising an active material operable to selectively modify the spring modulus of the spring (FIG. 5). The springs S_{1 . . . n} present differing characteristics, such as cross-sectional areas, pitches, or constituencies, such that the degree of modification from spring to spring varies when activated. For example, first and second SMA springs S_{1,2} having switchable Martensitic and Austenitic spring moduli may be connected in series as shown in FIG. 5. In operation, it is appreciated that where stretched to acquire potential energy, activation of one or more spring segments to its higher modulus state, will cause that segment and the actuator 10 to constrict where the higher modulus is greater than the load 100, thereby effecting a segmental stroke as previously discussed. In this configuration, the segments S_{1 . . . n} may be interconnected by mechanical plugs 14, such as a compressible body coaxially aligned and disposed within the coils of the springs S_{1,2} (FIG. 5). The body 14 remains compressed and frictionally engaged throughout the stroke. Again, to return potential energy to the actuator 10, an external return mechanism (not shown), e.g., the weight of the load 100, is preferably used to stretch the springs S_{1,2} once deactivated.

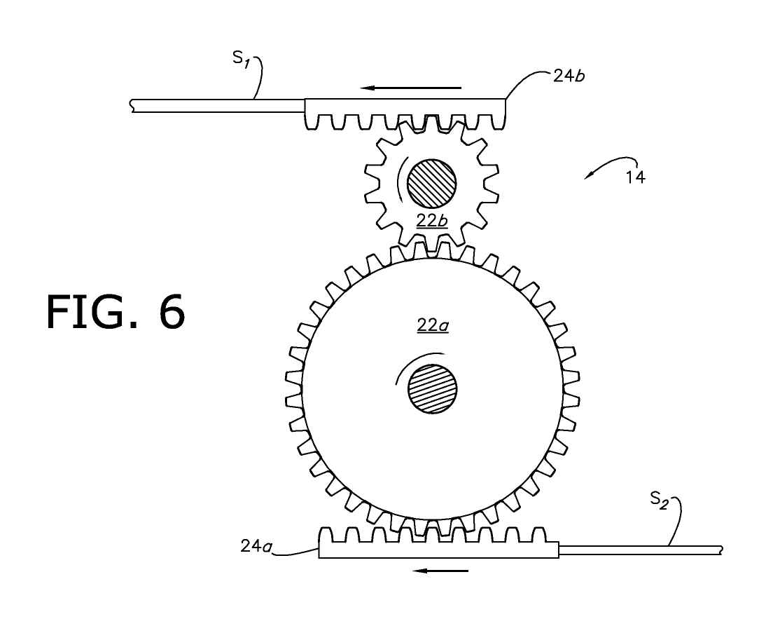

Lastly, in yet another embodiment, it is appreciated that the segments S_{1 . . . n} may be interconnected by at least one transmission 14 operable to modify (e.g., redirect) the driving force vector without invoking a bending stress in the actuator 10 (FIG. 6). More preferably, the transmission 14 is further configured to provide mechanical advantage, i.e., amplify the stroke or driving force. In FIG. 6, for example, a one-way transmission 14, consisting of first and second sprocket gears 22a,b, is shown interconnecting first and second segments S_{1,2} having differing diameters. In the illustrated embodiment, the gears 22a,b present relatively large and small radii. The segments S_{1,2} are drivenly connected to toothed racks 24a, b that are engaged to the gears 22a, b respectively. It is appreciated that in this configuration, an even number of intermediate gears will maintain the force vector direction, whereas an odd number (e.g., single) gear configuration will alternatively reverse the vector direction to produce a back-and-forth motion. The illustrated gear ratio results in mechanical advantage with respect to force, but may be converted to magnify distance by reversing the gears 22a,b. As a result, where a larger than necessary diameter wire is employed within the actuator 10 to effect the variable timing of the present invention, the excess force associated therewith can be stepped-down in lieu of greater stroke without concern. It is appreciated that upstream segments produce input into the transmission 14, while downstream segments operate without benefit; and therefore, that it is preferable to distally locate an advantageous transmission 14.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

What is claimed is:

1. An actuator adapted to produce a variable, tailored, or staged stroke, so as to variably or incrementally drive a load, said actuator comprising:
a plurality of segments,
each segment formed at least in part by an active material operable to undergo a reversible change in fundamental property when exposed to or occluded from an activation signal, presenting a constituency and geometric configuration, and defining an activation threshold, and activation range/period,
wherein the change produces a driving force and an individual segment stroke based on the constituency and configuration,
wherein the segments are fixedly interconnected and physically joined in series, such that the force acts upon the plurality of segments,
wherein the segments define differing thresholds, differing ranges/periods, and/or differing individual strokes.

2. The actuator as claimed in claim 1, wherein a first portion of the segments are formed at least in part by a first active material, and a second portion of the segments are formed at least in part by a second active material differing from the first active material.

3. The actuator as claimed in claim 1, wherein the active material is selected from the group consisting essentially of shape memory alloys, ferromagnetic shape memory alloys, electroactive polymers, magnetorheological elastomers, electrorheological elastomers, magnetostrictives, carbon nanofibers, and high-output-paraffin wax actuators.

4. The actuator as claimed in claim 1, wherein the active material is shape memory alloy, the activation threshold is at least one of the Martensitic and Austenitic transformation start and finish temperatures of the shape memory alloy, and the activation range/period is based on the transformation temperature range between the Martensitic finish and Austenitic finish temperatures of the shape memory alloy.

5. The actuator as claimed in claim 4, wherein the segments present differing constituencies, and define different transformation start temperatures and/or transformation temperature ranges as a result of the differing constituencies.

6. The actuator as claimed in claim 4, wherein the segments present differing geometric configurations, and define different transformation start temperatures and/or transformation temperature ranges as a result of the differing configurations.

7. The actuator as claimed in claim 6, wherein the differing geometric configurations include differing diameters.

8. The actuator as claimed in claim 1, wherein the geometric configurations include at least one wire.

9. The actuator as claimed in claim 1, wherein the differing geometric configurations include differing plurality of wires, so as to define differing exposed surface areas.

10. The actuator as claimed in claim 1, wherein the segments are interconnected by weld beads.

11. The actuator as claimed in claim 1, wherein the segments are interconnected by crimps.

12. The actuator as claimed in claim 1, wherein the segments are interconnected by epoxy, adhesive, or cement.

13. The actuator as claimed in claim 1, wherein the geometric configurations are springs.

14. The actuator as claimed in claim 13, wherein the segments are interconnected by mechanical plugs.

15. The actuator as claimed in claim 1, wherein the segments constrict when activated, and are interconnected by flexible tensile elements.

16. The actuator as claimed in claim 1, wherein the segments are interconnected by a transmission.

17. The actuator as claimed in claim 16, wherein the transmission produces mechanical advantage.

18. The actuator as claimed in claim 17, wherein the transmission includes at least one gear.

19. An actuator adapted to produce a variable, tailored, or staged stroke, so as to variably or incrementally drive a load, said actuator comprising:
a plurality of segments,
each segment formed at least in part by shape memory alloy, presenting a constituency and a wire configuration defining a diameter, and further defining a transformation start temperature, and transformation temperature range/period based on the constituency and configuration,
wherein the change produces a driving force and an individual segment stroke,
wherein the segments present differing constituencies and/or configurations, so as to further define differing start temperatures, differing ranges/periods, and/or differing individual strokes; and
at least one interconnecting element intermediately and fixedly joining the segments in series, such that the force acts upon the plurality of segments,
said at least one element being selected from the group consisting essentially of weld beads, tensile elements, crimp connectors, mechanical plugs, transmissions, epoxy, adhesive, and cement.
